(19) United States
(12) Patent Application Publication
(10) Pub. No.: US 2026/0094278 A1
(43) Pub. Date: Apr. 2, 2026

(54) IMAGE PROCESSING METHOD AND APPARATUS, DEVICE, AND MEDIUM

(71) Applicant: Beijing Zitiao Network Technology Co., Ltd., Beijing (CN)

(72) Inventors: Guang ZENG, Beijing (CN); Jiamin CUI, Beijing (CN)

(21) Appl. No.: 19/266,651

(22) Filed: Jul. 11, 2025

(30) Foreign Application Priority Data
Sep. 27, 2024 (CN) 202411364503.7

(51) Int. Cl. G06T 7/12; G06T 5/73

(52) U.S. Cl. CPC G06T 7/12; G06T 5/73

(57) ABSTRACT

An image processing method and apparatus, a device and a medium are provided. The method includes: acquiring a first image and a first noise map, where the first image contains a target object, and a transparency of the target object in the first image is different from that of an area outside an edge of the target object; performing blurring processing on the first image, to obtain a blurred image corresponding to the first image; and generating a second image corresponding to the first image based on transparency information of the blurred image and the first noise map, where an edge of a target object in the second image is obtained by applying the first noise map to the edge of the target object in the first image based on the transparency information of the blurred image.

### CROSS-REFERENCE TO RELATED APPLICATION

The present application claims priority to Chinese Patent Application No. 202411364503.7, filed on September 27, 2024, which is incorporated herein by reference in its entirety as a part of the present application.

### TECHNICAL FIELD

The present disclosure relates to the technical field of image processing, in particular to an image processing method and apparatus, a device, and a medium.

### BACKGROUND

Nowadays, more and more ordinary users, professional editors and other people need to use multimedia editing software to edit the captured images. Most of the existing multimedia editing software can provide effects processing function to enhance the emotional appeal and the entertainment value of images.

### SUMMARY

In order to solve or at least partially solve the above technical problems, the present disclosure provides an image processing method and apparatus, a device, and a medium.

Embodiments of the present disclosure provides an image processing method, including: acquiring a first image and a first noise map, where the first image contains a target object, and a transparency of the target object in the first image is different from that of an area outside an edge of the target object; performing blurring processing on the first image to obtain a blurred image corresponding to the first image; and generating a second image corresponding to the first image based on transparency information of the blurred image and the first noise map, where an edge of a target object in the second image is obtained by applying the first noise map to the edge of the target object in the first image based on the transparency information of the blurred image.

Optionally, the generating a second image corresponding to the first image based on transparency information of the blurred image and the first noise map includes: generating a second noise map based on the transparency information of the blurred image and the first noise map; and obtaining a second image corresponding to the first image based on the second noise map and the first image.

Optionally, in response to a transparency of a second pixel point in the blurred image corresponding to a first pixel point in the first noise map being closer to 0, a pixel value of a third pixel point in the second noise map corresponding to the first pixel point is closer to a pixel value of the first pixel point; and in response to a transparency of the second pixel point corresponding to the first pixel point being closer to 1, the pixel value of the third pixel corresponding to the first pixel is closer to 1; where coordinate positions of the first pixel point, the second pixel point and the third pixel point are all the same.

Optionally, the obtaining a second image corresponding to the first image based on the second noise map and the first image includes: acquiring an edge sharpness parameter; performing sharpness adjustment processing on the second noise map based on the edge sharpness parameter to obtain a third noise map; and obtaining the second image corresponding to the first image based on the third noise map and the first image.

Optionally, the obtaining the second image corresponding to the first image based on the third noise map and the first image includes: adjusting the transparency information of the blurred image based on the third noise map to obtain target transparency information; and obtaining the second image corresponding to the first image based on the target transparency information and the first image.

Optionally, the performing sharpness adjustment processing on the second noise map based on the edge sharpness parameter to obtain a third noise map includes: performing the sharpness adjustment processing on the second noise map based on the edge sharpness parameter by using a smooth step algorithm to obtain the third noise map.

Optionally, the performing blurring processing on the first image to obtain a blurred image corresponding to the first image includes: acquiring a blur radius parameter; and performing Gaussian blurring processing on the first image based on the blur radius parameter to obtain the blurred image corresponding to the first image.

An embodiment of the present disclosure further provides an image processing apparatus, including: an image acquisition module, configured to acquire a first image and a first noise map, where the first image contains a target object, and a transparency of the target object in the first image is different from that of an area outside an edge of the target object; a blurring processing module, configured to perform blurring processing on the first image to obtain a blurred image corresponding to the first image; and an image generation module, configured to generate a second image corresponding to the first image based on transparency information of the blurred image and the first noise map, where an edge of a target object in the second image is obtained by applying the first noise map to the edge of the target object in the first image based on the transparency information of the blurred image.

An embodiment of the present disclosure further provides an electronic device, including: a storage device, on which a computer program is stored; and a processing device, configured to execute the computer program in the storage device to implement the image processing method provided by an embodiment of the present disclosure.

An embodiment of the present disclosure further provides a non-transitory computer-readable storage medium on which a computer program is stored, where the computer program is configured to cause at least one processor to implement the image processing method provided by an embodiment of the present disclosure.

It should be understood that what is described in this section is not intended to identify key or important features of the embodiments of the present disclosure, nor is it intended to limit the scope of the present disclosure. Other features of the present disclosure will be readily understood from the following description.

### BRIEF DESCRIPTION OF DRAWINGS

The accompanying drawings, which are incorporated in and constitute a part of this specification, illustrate embodiments consistent with the present disclosure and together with the description, serve to explain the principles of the present disclosure.

In order to explain the technical solutions in the embodiments of the present disclosure or the prior art more clearly, the drawings necessary for the description of the embodiments or the prior art will be briefly introduced below. Obviously, for ordinary skilled in the art, other drawings can be obtained according to these drawings without creative labors.

FIG. 1 is a flowchart of an image processing method provided by an embodiment of the present disclosure;

FIG. 2 is a flowchart of an image processing method provided by an embodiment of the present disclosure;

FIG. 3 is a schematic diagram of image processing provided by an embodiment of the present disclosure;

FIG. 4 is a schematic structural diagram of an image processing apparatus provided by an embodiment of the present disclosure; and

FIG. 5 is a schematic structural diagram of an electronic device provided by an embodiment of the present disclosure.

### DETAILED DESCRIPTION

In order to understand the above objects, features and advantages of the present disclosure more clearly, the technical solutions of the present disclosure will be further described below. It should be noted that the embodiments of the present disclosure and the features in the embodiments can be combined with each other without conflict.

In the following description, many specific details are set forth in order to fully understand the present disclosure, but the present disclosure may be practiced in other ways than those described herein. Obviously, the embodiments in the specification are only part of the embodiments of the present disclosure, not all of them.

Through research, the inventors found that existing methods for applying effects to object edges in images are ineffective. For example, these methods require users to determine the object edges and manually adjust the object edges to achieve feathered edge effects, resulting in poor efficiency.

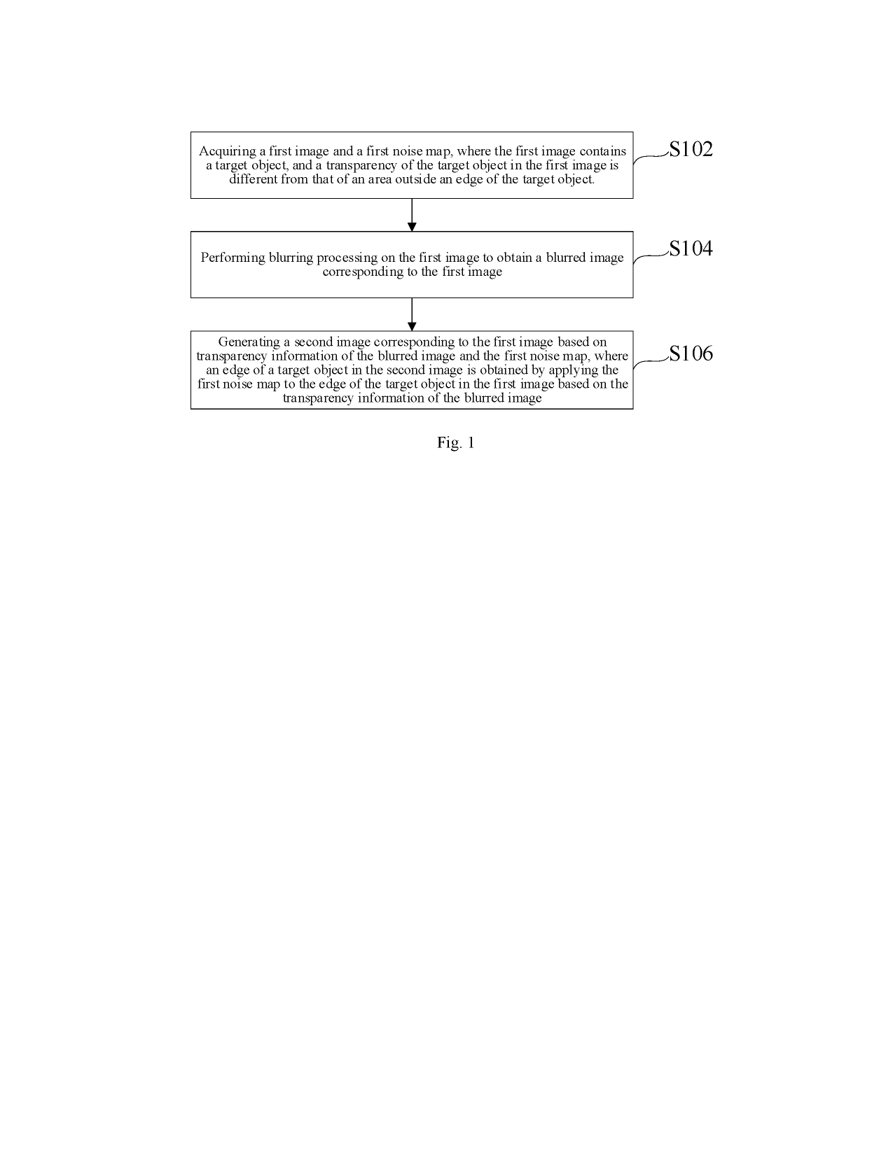

FIG. 1 is a flowchart of an image processing method provided by an embodiment of the present disclosure, which can be executed by an image processing apparatus. The apparatus may be implemented by software and/or hardware, and generally can be integrated in an electronic device. As shown in FIG. 1, the method mainly includes the following steps S102~ to S106:

S102, acquiring a first image and a first noise map; where the first image contains a target object, and a transparency of the target object in the first image is different from that of an area outside an edge of the target object.

For example, the target object in the first image is a foreground object, and the area outside the edge of the target object is a background area, and the transparency of the foreground object is different from that of the background area in the first image. Illustratively, the target object is completely opaque, and the transparency is 1; the area outside the edge of the target object is completely transparent, and the transparency is 0. It should be emphasized that the above is only illustrative and should not be regarded as limiting. Any image that requires edge effects (such as feathered edge effects) can be used as the first image, and the embodiment of the present disclosure does not limit the acquisition method of the first noise map. It may directly acquire the existing noise map or generate the first noise map by using a noise algorithm.

Step S104: performing blurring processing on the first image to obtain a blurred image corresponding to the first image.

The embodiment of the present disclosure does not limit the blurring processing mode. For example, the blurring processing mode can include Gaussian blurring processing, which can usually bring great influence to the areas with transparency differences. Therefore, although the blurring processing is performed on the first image, the main part affected by the blurring processing in the first image is the edge of the object, which is embodied in that a blurred transition area is usually added between the edge of the object and the area outside the edge. This transition area can realize the gradient transition of transparency, color and other information between the edge of the object and the area outside the edge. Among them, the transition area can be referred to as a joint area or an edge area. For example, if the target object is completely opaque and the background area is completely transparent, the transition area can be gradually translucent.

Step S106, generating a second image corresponding to the first image based on transparency information of the blurred image and the first noise map; where the edge of the target object in the second image is obtained by applying the first noise map to the edge of the target object in the first image based on the transparency information of the blurred image. The edge information of the target object in the second image is different from the edge information of the target object in the first image. For example, the edge information includes one or more of clarity, sharpness and smoothness. With the aid of the transparency information of the blurred image, the edge area of the object can be clearly indicated, and then combined with the noise map, the target object in the generated second image can have a rough feathered edge effect.

According to the technical solution provided by the embodiment of the present disclosure, considering that the blurring processing usually has the greatest influence on the edge of an object with transparency differences, firstly, the first image can be subject to a transparency processing skillfully, and then a second image with the edge of the object affected by noise can be generated by combining the transparency information of the blurred image with the first noise map, that is, the edge of the target object in the second image is obtained by applying the first noise map to the edge of the target object in the first image based on the transparency information of the blurred image, so that the effect processing for the edge of the object can be realized efficiently and conveniently. Since the edge of the object affected by noise usually presents a rough or broken, feathered impression to the users, the above method can realize the feathered edge effects without the need for the users to determine the edge of the object and manually adjust the edge of the object, which can effectively improve the realization efficiency of the feathered edge effects.

In order to allow the blurring effects to meet the diverse needs of users, in some embodiments, the above step S104, that is, the step of performing blurring processing on the first image to obtain a blurred image corresponding to the first image, can be performed with reference to the following steps a and b:

Step a, acquiring a blur radius parameter. In practical application, users can be provided with controls for adjusting blur radius parameters, so that users can flexibly set blur radius parameters according to their needs.

Step b, performing Gaussian blurring processing on the first image based on the blur radius parameter, to obtain a blurred image corresponding to the first image. The above method enables the user to adjust the final blurring range according to the requirements, so as to improve the degree of blur of the blurred image. In this way, it facilitates adjusting the blurring range of the edge of the object in the second image based on the blurred image subsequently. It can be understood that the larger the blur radius, the broader the range of feathered edge effects in the second image as finally obtained.

In order to efficiently and conveniently apply the first noise map to the edge of the target object in the first image based on the transparency information of the blurred image so as to obtain a second image in which the edge of the object is affected by noise, in some embodiments, the above step S106, that is, the step of generating a second image corresponding to the first image based on transparency information of the blurred image and the first noise map, can be executed with reference to the following steps A and B:

Step A, generating a second noise map based on the transparency information of the blurred image and the first noise map.

For example, if the transparency of the second pixel point in the blurred image corresponding to the first pixel point in the first noise map is closer to 0, the pixel value of the third pixel point in the second noise map corresponding to the first pixel point is closer to the pixel value of the first pixel point; and if the transparency of the second pixel point corresponding to the first pixel point is closer to 1, the pixel value of the third pixel point corresponding to the first pixel point is closer to 1; where the coordinate positions of the first pixel point, the second pixel point and the third pixel point are all the same. Among them, the pixel value in the noise map is equivalent to the brightness value, which can also be referred to as gray value or noise value.

For the sake of understanding, if the transparency of the blurred image is a and the pixel value of the first noise map is n1, the pixel value of the second noise map is n2=a+(1-a)*n1. That is, with the change of a from 0 to 1, the value of n2 will change from n1 to 1. The main function of the above method is to limit the effect of the second noise map in areas where noise is not needed to be added, such as opaque areas. It should be explained that the working principle of the noise map is usually to act on the transparency of the image to be added with noise through multiplication. If the pixel value of a pixel point in the noise map is 1, it indicates that a pixel point in the image to be added with noise that corresponds to the pixel point in the noise map will not be affected by noise. For example, the target object is completely opaque and the transparency is 1; at this time, the pixel values corresponding to the internal area of the target object in the second noise map are all 1, so the noise map will not act on the internal area of the target object. By changing the noise values of the noise map based on transparency, the above method can prevent the noise map from introducing noise influence across the entire image, and instead confine the noise effects on the blurred, edge area of the object, thus achieving rough and feathered edge effects of the object.

Step B, obtaining the second image corresponding to the first image based on the second noise map and the first image. In some embodiments, the second noise map can be directly fused with the first image, that is, the second noise map can be applied to the first image to obtain the second image. In other embodiments, in order to further meet the diverse needs of users, the sharpness of the edge of the generated object with a feathered edge effect can also be adjusted. For example, step B can be executed with reference to the following steps B1 to B3:

Step B1, acquiring an edge sharpness parameter. In practical application, users can be provided with controls for adjusting edge sharpness parameters, so that users can flexibly set the edge sharpness parameters according to their needs.

B2, performing sharpness adjustment processing on the second noise map based on the edge sharpness parameter to obtain a third noise map.

In some specific implementation examples, the sharpness adjustment processing can be performed on the second noise map based on the edge sharpness parameter by using a smooth step algorithm to obtain the third noise map. Among them, the smooth step algorithm can also be referred to as the smooth step function.

For the sake of understanding, if the pixel value of the second noise map is n2, it can be obtained that the pixel value of the third noise map is n3=smoothstep(s*0.5, 1-s*0.5, n2). Among them, smoothstep () represents a smooth step function, and s is an edge sharpness parameter with a value range of 0~1. The specific implementation of the smooth step function can refer to related technologies, and will not be described here. In this way, the noise value can be further adjusted on the basis of the second noise map, so that the obtained third noise map can effectively adjust the sharpness of the edge of the object.

Step B3: obtaining the second image corresponding to the first image based on the third noise map and the first image.

In practical application, the third noise map can be fused with the first image to obtain the second image corresponding to the first image. In some specific embodiments of step B3, the transparency information of the blurred image can be adjusted based on the third noise map, to obtain the target transparency information; based on the target transparency information and the first image, a second image corresponding to the first image is obtained. Specifically, the third noise map can be multiplied by the transparency of the blurred image to obtain the target transparency information, and then the second image can be obtained based on the target transparency information and the color channel information of the first image.

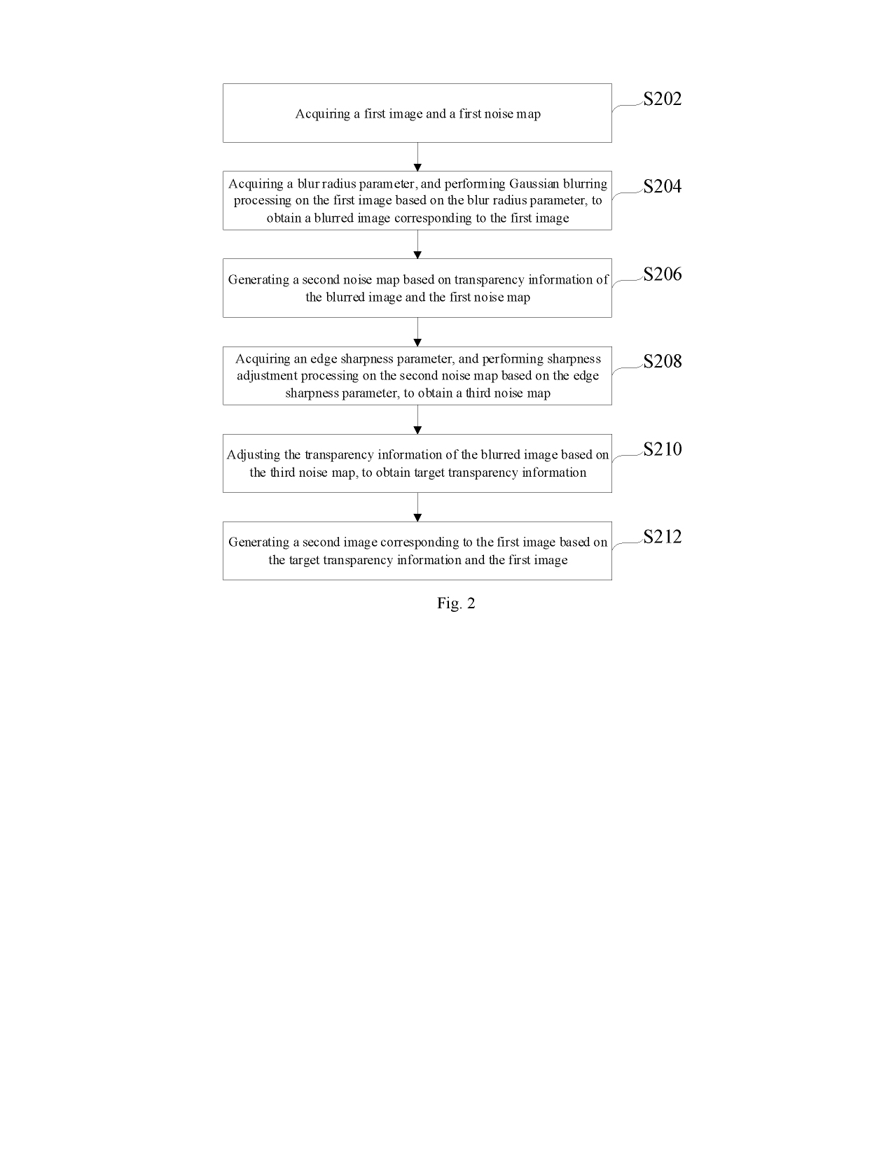

Based on the foregoing, referring to the flowchart of FIG. 2, an image processing method mainly includes the following steps S202~S212:

S202, acquiring a first image and a first noise map; where the first image contains a target object, and a transparency of the target object in the first image is different from that of an area outside an edge of the target object.

Step S204: acquiring a blur radius parameter, and performing Gaussian blurring processing on the first image based on the blur radius parameter, to obtain a blurred image corresponding to the first image.

Step S206, generating a a second noise map based on transparency information of the blurred image and the first noise map.

Step S208: acquiring an edge sharpness parameter, and performing sharpness adjustment processing on the second noise map based on the edge sharpness parameter, to obtain a third noise map.

Step S210: adjusting the transparency information of the blurred image based on the third noise map, to obtain target transparency information.

Step S212: generating a second image corresponding to the first image based on the target transparency information and the first image.

For the specific implementation of the above steps, reference can be made to the relevant contents in the foregoing, and will not be repeated here. Through the above-mentioned method, the second image in which the edge of the object exhibits feathered edge effects can be generated efficiently and conveniently without manually determining the edge of the object and manually processing, and the user can also adjust the feathered edge effects by adjusting the blur radius parameter and the edge sharpness parameter as required.

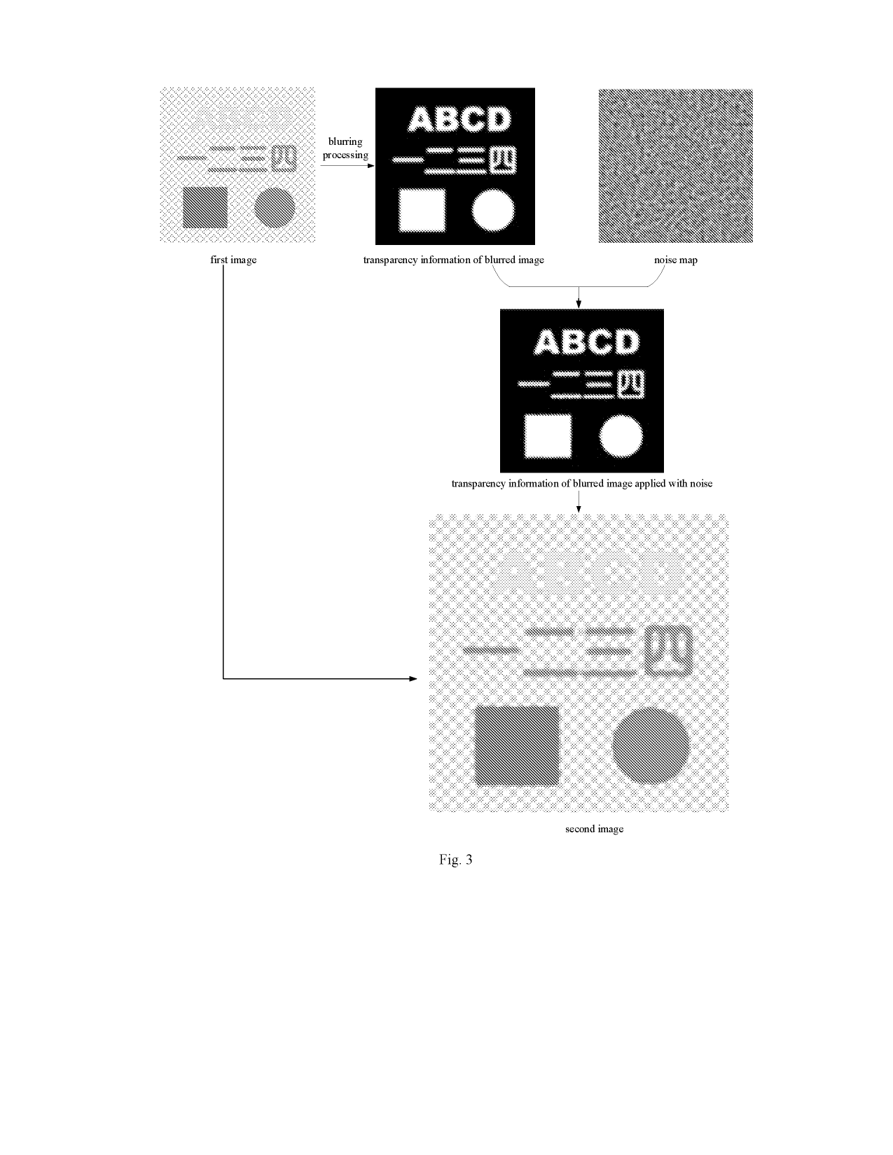

For the convenience of understanding, simple reference can be made to the schematic diagram of image processing in FIG. 3, which shows that the first image contains letters (ABCD), Chinese characters (1234) and figures(squares and circles). The above-mentioned letters, Chinese characters and figures can all be used as target objects. For the convenience of understanding, in FIG. 3, the transparency information of the blurred image is presented mainly in the form of black and white graphs. Generally, a transparency of 0 means complete transparency, a transparency of 1 means complete opacity, while the black is usually represented by 0 and the white is represented by 1. Therefore, in the transparency information of blurred images, the target objects are mainly presented in white and the background areas are presented in black, and a gradient blurring transition between the edge of the target object and the background area can be seen from the graphs representing the transparency information of blurred images. After that, the noise map (only the final noise map is simply shown in FIG. 3, such as the third noise map) is applied to the transparency information of the blurred image, and the transparency information (that is, the target transparency information) of the blurred image on which the noise has been applied can be obtained. From the schematic diagram corresponding to this information, it can be clearly seen that the edge of the target object has a rough feathered edge effect. In addition, it should be noted that the sizes of all the images involved in FIG. 3 are the same. The enlargement of the generated second image in FIG. 3 is only for the convenience of clearly illustrating the feathered edge effect of the target object and does not mean that the size of the second image is larger than that of other images.

To sum up, the image processing method provided by the embodiment of the present disclosure can effectively and conveniently obtain the feathered edge effect only acting on the edge of the object by combining the transparency of the blurred image with the noise image, and the user can also fine-tune the parameters of the blurred image and the noise image according to the requirements, so that the edge of the object can obtain different feathered shapes, thereby meeting the diverse needs of the user.

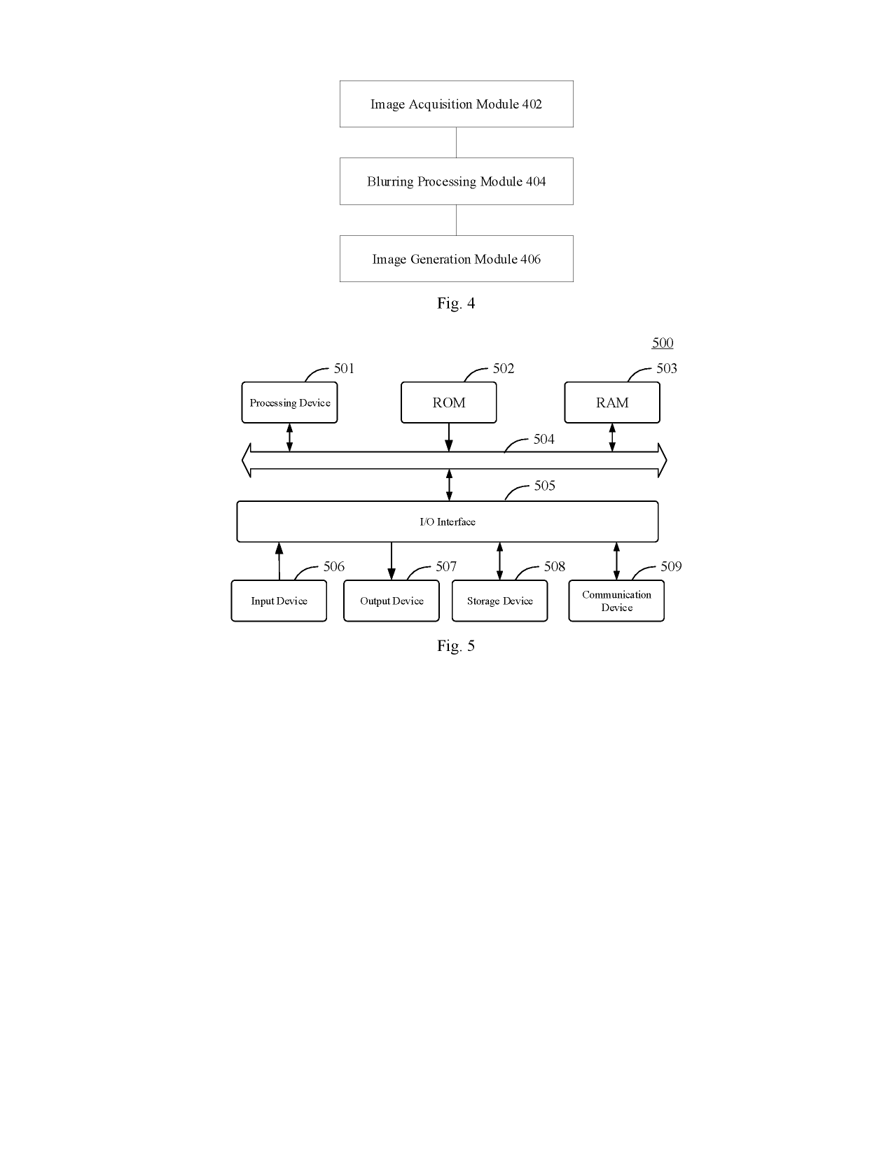

An embodiment of the present disclosure further provides an image processing apparatus, and FIG. 4 is a schematic structural diagram of an image processing apparatus provided by the embodiment of the present disclosure. The apparatus can be realized by software and/or hardware, and can be generally integrated in an electronic device. As shown in FIG. 4, the image processing apparatus includes:

an image acquisition module 402, configured to acquire a first image and a first noise map; where the first image contains a target object, and a transparency of the target object in the first image is different from that of an area outside an edge of the target object;

a blurring processing module 404, configured to perform blurring processing on the first image to obtain a blurred image corresponding to the first image;

an image generation module 406, configured to generate a second image corresponding to the first image based on transparency information of the blurred image and the first noise map; where an edge of a target object in the second image is obtained by applying the first noise map to the edge of the target object in the first image based on the transparency information of the blurred image.

According to the apparatus provided by the embodiment of the present disclosure, considering that the blurring processing usually has the greatest influence on the edge of an object with transparency differences, firstly, the first image can be subject to a transparency processing skillfully, and then a second image with the edge of the object affected by noise can be generated by combining the transparency information of the blurred image with the first noise map, that is, the edge of the target object in the second image is obtained by applying the first noise map to the edge of the target object in the first image based on the transparency information of the blurred image, so that the effect processing for the edge of the object can be realized efficiently and conveniently. Since the edge of the object affected by noise usually presents a rough or broken, feathered impression to the users, the above method can realize the feathered edge effects without the need for the users to determine the edge of the object and manually adjust the edge of the object, which can effectively improve the realization efficiency of the feathered edge effects.

In some embodiments, the image generation module 406 is, for example, configured to: generate a second noise map based on the transparency information of the blurred image and the first noise map; and obtain the second image corresponding to the first image based on the second noise map and the first image.

In some embodiments, if the transparency of a second pixel point in the blurred image corresponding to a first pixel point in the first noise map is closer to 0, the pixel value of a third pixel point in the second noise map corresponding to the first pixel point is closer to the pixel value of the first pixel point; and if the transparency of the second pixel point corresponding to the first pixel point is closer to 1, the pixel value of the third pixel point corresponding to the first pixel point is closer to 1; where the coordinate positions of the first pixel point, the second pixel point and the third pixel point are all the same.

In some embodiments, the image generation module 406 is, for example, configured to: acquire an edge sharpness parameter; perform sharpness adjustment processing on the second noise map based on the edge sharpness parameter to obtain a third noise map; and obtain a second image corresponding to the first image based on the third noise map and the first image.

In some embodiments, the image generation module 406 is, for example, configured to: adjust the transparency information of the blurred image based on the third noise map to obtain target transparency information; and obtain the second image corresponding to the first image based on the target transparency information and the first image.

In some embodiments, the image generation module 406 is, for example, configured to: perform sharpness adjustment processing on the second noise map by using a smooth step algorithm based on the edge sharpness parameter, to obtain a third noise map.

In some embodiments, the blurring processing module 404 is, for example, configured to: obtain a blur radius parameter; perform Gaussian blurring processing on the first image based on the blur radius parameter to obtain the blurred image corresponding to the first image.

The image processing apparatus provided by the embodiment of the present disclosure can execute the image processing method provided by any embodiment of the present disclosure, and has corresponding functional modules and beneficial effects.

It can be clearly understood by those skilled in the art that for the convenience and conciseness of description, the specific working process of the apparatus embodiment described above can refer to the corresponding process in the method embodiment, and will not be repeated here.

An embodiment of the present disclosure provides an electronic device, which includes: a storage device configured to store computer program; and a processing device configured to execute the computer program in the storage device to realize the steps of any method in the present disclosure.

Reference is now made to FIG. 5, which shows a schematic structural diagram of an electronic device 500 suitable for implementing an embodiment of the present disclosure. The terminal devices in the embodiment of the present disclosure may include, but are not limited to, mobile terminals such as mobile phones, notebook computers, digital broadcast receivers, PDA (Personal Digital Assistant), PAD (Tablet Computer), PMP (Portable Multimedia Player), vehicle-mounted terminals (such as vehicle-mounted navigation terminals), and fixed terminals such as digital TV and desktop computers. The electronic device shown in FIG. 5 is only an example, and should not bring any limitation to the function and application scope of the embodiment of the present disclosure.

As shown in FIG. 5, the electronic device 500 may include a processing device (such as a central processing unit, a graphics processor, etc.) 501, which may perform various appropriate actions and processes according to a program stored in a read-only memory (ROM) 502 or a program loaded from a storage device 508 into a random-access memory (RAM) 503. In the RAM 503, various programs and data required for the operation of the electronic device 500 are also stored. The processing device 501, the ROM 502 and the RAM 503 are connected to each other through a bus 504. An input/output (I/O) interface 505 is also connected to the bus 504.

Generally, the following devices can be connected to the I/O interface 505: an input device 506 including, for example, a touch screen, a touch pad, a keyboard, a mouse, a camera, a microphone, an accelerometer, a gyroscope, etc.; an output device 507 including, for example, a liquid crystal display (LCD), a speaker, a vibrator, etc.; a storage device 508 such as a magnetic tape, a hard disk, etc.; and a communication device 509. The communication device 509 may allow the electronic device 500 to have wireless or wired communication with other devices to exchange data. Although FIG. 5 shows an electronic device 500 with various devices, it should be understood that it is not required to implement or have all the devices as shown. More or fewer devices may alternatively be implemented or provided.

In particular, according to an embodiment of the present disclosure, the process described above with reference to the flowchart can be implemented as a computer software program. For example, an embodiment of the present disclosure includes a computer program product including a computer program carried on a non-transitory computer-readable medium, which contains program code for executing the method shown in the flowchart. In such an embodiment, the computer program can be downloaded and installed from the network through the communication device 509, or installed from the storage device 508 or from the ROM 502. When the computer program is executed by the processing device 501, the above functions defined in the method of the embodiment of the present disclosure are performed.

In addition to the above methods and devices, embodiments of the present disclosure may also be computer program products, which include computer program instructions that, when executed by a processor, cause the processor to execute the image processing methods provided by the embodiments of the present disclosure. The computer program product can write program codes for performing the operations of the embodiments of the present disclosure in any combination of one or more programming languages, including object-oriented programming languages such as Java, C++, and conventional procedural programming languages such as "C" or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

In addition, the embodiment of the present disclosure can also be a computer-readable storage medium, on which computer program instructions are stored, which, when executed by a processor, cause the processor to execute the image processing method provided by the embodiment of the present disclosure.

The computer-readable storage medium can adopt any combination of one or more readable medium. The readable medium may be a readable signal medium or a readable storage medium. The readable storage medium may include, for example, but be not limited to, an electrical, magnetic, optical, electromagnetic, infrared, or semiconductor system, apparatus or device, or a combination of any of the above. More specific examples (a non-exhaustive list) of readable storage medium may include: an electrical connection based on one or more wires, a portable computer disk, a hard disk, a random-access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

Embodiments of the present disclosure further provide a computer program product, including computer programs/instructions, which, when executed by a processor, realize the image processing method in embodiments of the present disclosure.

It can be understood that before using the technical solutions disclosed in each embodiment of this disclosure, users should be informed of the types, application scope and application scenarios of personal information involved in the present disclosure in an appropriate way in accordance with relevant laws and regulations, and authorization from the users should be acquired.

For example, in response to receiving the user's active request, prompt information is sent to the user to clearly remind the user that the operation requested by the user will require obtaining and using the user's personal information. Therefore, the user can autonomously choose whether to provide personal information to software or hardware such as electronic devices, applications, servers or storage medium that perform the operation of the technical solution of the present disclosure according to the prompt information.

As an optional but non-limiting implementation, in response to receiving the user's active request, the way to send the prompt information to the user can be, for example, a pop-up window, in which the prompt information can be presented in text. In addition, the pop-up window can also carry a selection control for the user to choose "agree" or "disagree" to provide personal information to the electronic device.

It can be understood that the above-mentioned process of notifying and obtaining user authorization is only schematic and does not limit the implementation of the present disclosure, and other ways to meet relevant laws and regulations can also be applied to the implementation of the present disclosure.

It should be noted that relational terms such as "first" and "second" here are only used to distinguish one entity or operation from another entity or operation, and do not necessarily require or imply that there is any such actual relationship or order between these entities or operations. Moreover, the terms "comprising", "including" or any other variation thereof are intended to cover non-exclusive inclusion, so that a process, method, article or apparatus including a series of elements includes not only those elements, but also other elements not explicitly listed or elements inherent to such process, method, article or apparatus. Without further restrictions, an element defined by the phrase "comprising/including one/a/an…" does not exclude the existence of other identical elements in the process, method, article or apparatus including the element.

What has been described above is only the specific embodiments of the present disclosure, so that those skilled in the art can understand or realize the present disclosure. Many modifications to these embodiments will be obvious to those skilled in the art, and the general principles defined herein can be implemented in other embodiments without departing from the spirit or scope of the present disclosure. Therefore, the present disclosure will not be limited to the embodiments described herein, but is to be in accordance with the widest scope consistent with the principles and novel features disclosed herein.

1. An image processing method, comprising:
acquiring a first image and a first noise map, wherein the first image contains a target object, and a transparency of the target object in the first image is different from that of an area outside an edge of the target object;
performing blurring processing on the first image, to obtain a blurred image corresponding to the first image; and
generating a second image corresponding to the first image based on transparency information of the blurred image and the first noise map, wherein an edge of a target object in the second image is obtained by applying the first noise map to the edge of the target object in the first image based on the transparency information of the blurred image.

2. The method according to claim 1, wherein the generating a second image corresponding to the first image based on transparency information of the blurred image and the first noise map comprises:
generating a second noise map based on the transparency information of the blurred image and the first noise map; and
obtaining the second image corresponding to the first image based on the second noise map and the first image.

3. The method according to claim 2, wherein
in response to a transparency of a second pixel point in the blurred image corresponding to a first pixel point in the first noise map being closer to 0, a pixel value of a third pixel point in the second noise map corresponding to the first pixel point is closer to a pixel value of the first pixel point; and
in response to a transparency of the second pixel point corresponding to the first pixel point being closer to 1, the pixel value of the third pixel corresponding to the first pixel is closer to 1, wherein coordinate positions of the first pixel point, the second pixel point and the third pixel point are all the same.

4. The method according to claim 2, wherein the obtaining a second image corresponding to the first image based on the second noise map and the first image comprises:
acquiring an edge sharpness parameter;
performing sharpness adjustment processing on the second noise map based on the edge sharpness parameter, to obtain a third noise map; and
obtaining the second image corresponding to the first image based on the third noise map and the first image.

5. The method according to claim 4, wherein the obtaining the second image corresponding to the first image based on the third noise map and the first image comprises:
adjusting the transparency information of the blurred image based on the third noise map, to obtain target transparency information; and
obtaining the second image corresponding to the first image based on the target transparency information and the first image.

6. The method according to claim 4, wherein the performing sharpness adjustment processing on the second noise map based on the edge sharpness parameter, to obtain a third noise map comprises:
performing the sharpness adjustment processing on the second noise map based on the edge sharpness parameter by using a smooth step algorithm, to obtain the third noise map.

7. The method according to claim 1, wherein the performing blurring processing on the first image, to obtain a blurred image corresponding to the first image comprises:
acquiring a blur radius parameter; and
performing Gaussian blurring processing on the first image based on the blur radius parameter, to obtain the blurred image corresponding to the first image.

8. An electronic device, comprising:
a storage device, on which a computer program is stored; and
a processing device, configured to execute the computer program in the storage device to implement an image processing method, comprising:
acquiring a first image and a first noise map, wherein the first image contains a target object, and a transparency of the target object in the first image is different from that of an area outside an edge of the target object;
performing blurring processing on the first image, to obtain a blurred image corresponding to the first image; and
generating a second image corresponding to the first image based on transparency information of the blurred image and the first noise map, wherein an edge of a target object in the second image is obtained by applying the first noise map to the edge of the target object in the first image based on the transparency information of the blurred image.

9. The electronic device according to claim 8, wherein the generating a second image corresponding to the first image based on transparency information of the blurred image and the first noise map comprises:
generating a second noise map based on the transparency information of the blurred image and the first noise map; and
obtaining the second image corresponding to the first image based on the second noise map and the first image.

10. The electronic device according to claim 9, wherein
in response to a transparency of a second pixel point in the blurred image corresponding to a first pixel point in the first noise map being closer to 0, a pixel value of a third pixel point in the second noise map corresponding to the first pixel point is closer to a pixel value of the first pixel point; and
in response to a transparency of the second pixel point corresponding to the first pixel point being closer to 1, the pixel value of the third pixel corresponding to the first pixel is closer to 1, wherein coordinate positions of the first pixel point, the second pixel point and the third pixel point are all the same.

11. The electronic device according to claim 9, wherein the obtaining a second image corresponding to the first image based on the second noise map and the first image comprises:
acquiring an edge sharpness parameter;
performing sharpness adjustment processing on the second noise map based on the edge sharpness parameter, to obtain a third noise map; and
obtaining the second image corresponding to the first image based on the third noise map and the first image.

12. The electronic device according to claim 11, wherein the obtaining the second image corresponding to the first image based on the third noise map and the first image comprises:
adjusting the transparency information of the blurred image based on the third noise map, to obtain target transparency information; and
obtaining the second image corresponding to the first image based on the target transparency information and the first image.

13. The electronic device according to claim 11, wherein the performing sharpness adjustment processing on the second noise map based on the edge sharpness parameter, to obtain a third noise map comprises:
performing the sharpness adjustment processing on the second noise map based on the edge sharpness parameter by using a smooth step algorithm, to obtain the third noise map.

14. The electronic device according to claim 8, wherein the performing blurring processing on the first image, to obtain a blurred image corresponding to the first image comprises:
acquiring a blur radius parameter; and
performing Gaussian blurring processing on the first image based on the blur radius parameter, to obtain the blurred image corresponding to the first image.

15. A non-transitory computer-readable storage medium comprising a computer program stored thereon, wherein the computer program is configured to cause at least one processor to execute an image processing method, comprising:
acquiring a first image and a first noise map, wherein the first image contains a target object, and a transparency of the target object in the first image is different from that of an area outside an edge of the target object;
performing blurring processing on the first image, to obtain a blurred image corresponding to the first image; and
generating a second image corresponding to the first image based on transparency information of the blurred image and the first noise map, wherein an edge of a target object in the second image is obtained by applying the first noise map to the edge of the target object in the first image based on the transparency information of the blurred image.

16. The storage medium according to claim 15, wherein the generating a second image corresponding to the first image based on transparency information of the blurred image and the first noise map comprises:
generating a second noise map based on the transparency information of the blurred image and the first noise map; and
obtaining the second image corresponding to the first image based on the second noise map and the first image.

17. The storage medium according to claim 16, wherein
in response to a transparency of a second pixel point in the blurred image corresponding to a first pixel point in the first noise map being closer to 0, a pixel value of a third pixel point in the second noise map corresponding to the first pixel point is closer to a pixel value of the first pixel point; and
in response to a transparency of the second pixel point corresponding to the first pixel point being closer to 1, the pixel value of the third pixel corresponding to the first pixel is closer to 1, wherein coordinate positions of the first pixel point, the second pixel point and the third pixel point are all the same.

18. The storage medium according to claim 16, wherein the obtaining a second image corresponding to the first image based on the second noise map and the first image comprises:
acquiring an edge sharpness parameter;
performing sharpness adjustment processing on the second noise map based on the edge sharpness parameter, to obtain a third noise map; and
obtaining the second image corresponding to the first image based on the third noise map and the first image.

19. The storage medium according to claim 18, wherein the obtaining the second image corresponding to the first image based on the third noise map and the first image comprises:
adjusting the transparency information of the blurred image based on the third noise map, to obtain target transparency information; and
obtaining the second image corresponding to the first image based on the target transparency information and the first image.

20. The storage medium according to claim 18, wherein the performing sharpness adjustment processing on the second noise map based on the edge sharpness parameter, to obtain a third noise map comprises:
performing the sharpness adjustment processing on the second noise map based on the edge sharpness parameter by using a smooth step algorithm, to obtain the third noise map.
